(19) United States
(12) Patent Application Publication
(10) Pub. No.: US 2019/0331874 A1
(43) Pub. Date: Oct. 31, 2019

(54) LENS BARREL

(71) Applicant: Panasonic Intellectual Property Management Co., Ltd., Osaka (JP)

(72) Inventor: Naoki YOSHIKAWA, Osaka (JP)

(21) Appl. No.: 16/504,232

(22) Filed: Jul. 6, 2019

Related U.S. Application Data
(63) Continuation of application No. PCT/JP2018/001519, filed on Jan. 19, 2018.

(30) Foreign Application Priority Data
Jan. 24, 2017 (JP) 2017-010662

(51) Int. Cl. G02B 7/04

(52) U.S. Cl. CPC G02B 7/04

(57) ABSTRACT

A lens barrel includes: a fixed frame; a cam frame rotating with respect to the fixed frame; and a lens frame moving in conjunction with the rotation straight forward along the fixed frame. The fixed frame has a pair of first groove portions penetrating the fixed frame and extending substantially parallel with an optical axis. The lens frame includes: a first cam pin projecting from one of the first groove portions, and engages with the cam frame; a pair of straight keys guided by the pair of first groove portions; and an urging portion urging the first cam pin in the projecting direction. The first cam pin is only on one of the pair of straight keys. The pair of first groove portions are opposed to each other in the urging direction of the first cam pin with the optical axis interposed between the pair of first groove portions.

### CROSS REFERENCE TO RELATED APPLICATIONS

This application is a U.S. continuation application of PCT International Patent Application Number PCT/JP2018/001519 filed on Jan. 19, 2018, claiming the benefit of priority of Japanese Patent Application Number 2017-010662 filed on Jan. 24, 2017, the entire contents of which are hereby incorporated by reference.

### BACKGROUND

### 1. Technical Field

The present disclosure relates to a collapsible lens barrel.

### 2. Description of the Related Art

Japanese Unexamined Patent Application Publication No. 2016-145969 discloses a lens barrel in which three straight keys guided by a fixed frame and three cam pins (follower pins) guided by a cam frame are arranged at regular intervals along a periphery of a lens frame that moves relative to the fixed frame.

### SUMMARY

The present disclosure provides a lens barrel that can improve the accuracy of position of a lens frame while suppressing excessive restraint of the lens frame.

In accordance with the present disclosure, there is provided a lens barrel including: a fixed frame; a cam frame that rotates with respect to the fixed frame; and a lens frame that moves in conjunction with the rotation of the cam frame and moves straight forward along the fixed frame, wherein the fixed frame has a pair of first groove portions, the pair of first groove portions penetrating the fixed frame and extending substantially parallel with an optical axis. Here, the lens frame includes: a first cam pin that has a shape of a truncated cone, projects from one first groove portion of the pair of first groove portions, and engages with the cam frame; a pair of straight keys guided by the pair of first groove portions respectively; and an urging portion that urges the first cam pin in a projecting direction of the first cam pin. The first cam pin is provided only on one straight key of the pair of straight keys. The first groove portions in the pair are opposed to each other in an urging direction of the first cam pin with the optical axis interposed between the pair of first groove portions.

The lens barrel of the present disclosure can suppress excessive restraint of the lens frame and improve the accuracy of position of the lens frame.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a perspective view illustrating the outline of the configuration of a lens barrel according to an embodiment;

FIG. 2 is an exploded perspective view illustrating the lens barrel according to the embodiment;

FIG. 3 is a perspective view illustrating the schematic configuration of a fixed frame according to the embodiment;

FIG. 4 is a front view illustrating the schematic configuration of the fixed frame according to the embodiment;

FIG. 5 is a perspective view illustrating the schematic configuration of a two-group unit according to the embodiment;

FIG. 6 is a front view illustrating the schematic configuration of the two-group unit according to the embodiment;

FIG. 7 is a front view illustrating the two-group unit assembled into the fixed frame according to the embodiment;

FIG. 8 is a side view illustrating a first support portion assembled into the fixed frame according to the embodiment;

FIG. 9 is a schematic diagram illustrating the inner structure of the first support portion according to the embodiment;

FIG. 10 is a schematic diagram illustrating a compressed state of an urging portion according to the embodiment; and

FIG. 11 is a side view illustrating a second support portion assembled into the fixed frame according to the embodiment.

### DETAILED DESCRIPTION OF THE EMBODIMENTS

Hereinafter, certain exemplary embodiments are described in greater detail with reference to the accompanying Drawings. However, unnecessarily detailed description may be omitted. For example, detailed explanation of a well-known matter and repeated description of substantially identical structures may be omitted. Such omission makes the following description exclude unnecessary redundancy and be easily understood by those skilled in the art. It should also be noted that the following embodiments may include expressions using “substantially”, such as substantially parallel and substantially perpendicular. For example, substantially parallel means not only completely parallel but also substantially parallel. For example, substantially parallel includes a difference of about several % from completely parallel. The other expressions using “substantially” have the same meaning.

The inventors provide the accompanying drawings and the following explanation in order to sufficiently deepen the understanding of persons skilled in the art about the present disclosure. The inventors do not intend to limit the subject matter of claims

### [1. The Outline of the Configuration of a Lens Barrel]

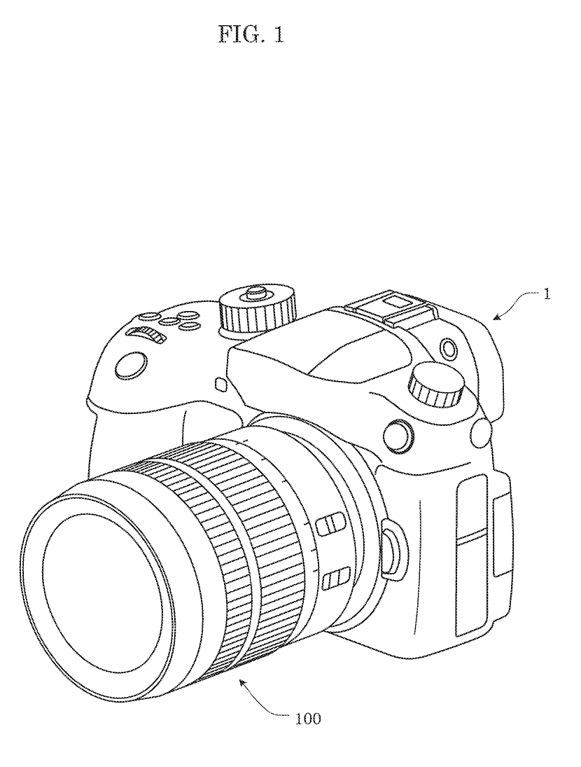

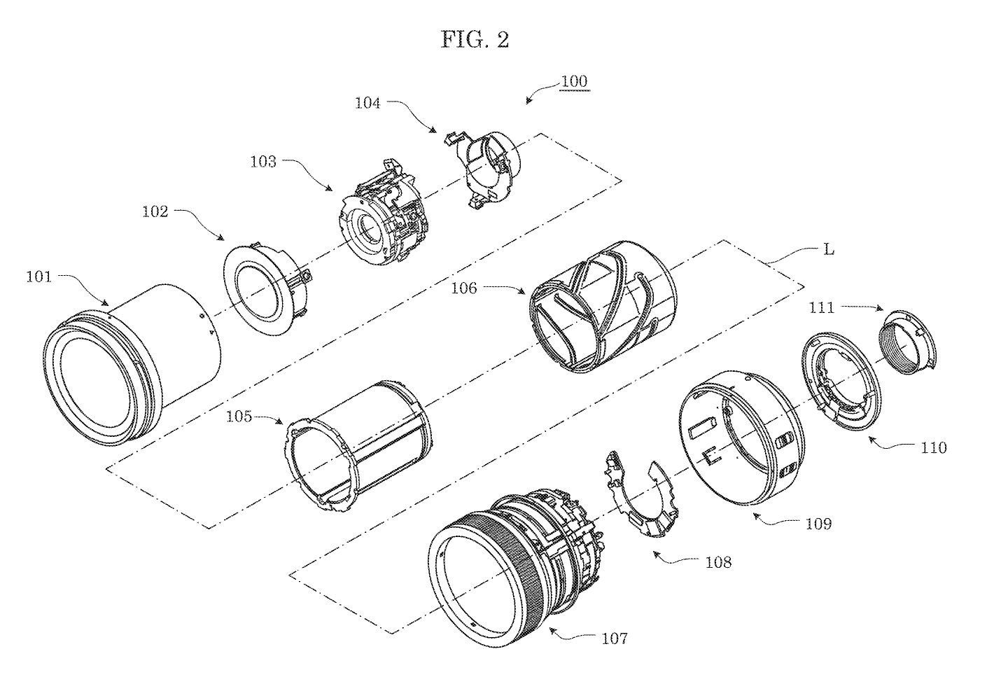

The configuration of a lens barrel according to an embodiment will be described below with reference to the accompanying drawings. FIG. 1 is a perspective view illustrating the outline of the configuration of lens barrel 100 according to the embodiment. FIG. 2 is an exploded perspective view illustrating lens barrel 100 according to the embodiment.

As illustrated in FIG. 1, lens barrel 100 is a zoom lens barrel detachably attached to camera body 1. As illustrated in FIG. 2, lens barrel 100 includes one-group unit 101, two-group unit 102, three-four group unit 103, five-group unit 104, fixed frame 105, cam frame 106, and exterior unit 107.

Lens barrel 100 is completed by assembling the components in the following order: first, fixed frame 105, five-group unit 104, three-four group unit 103, and two-group unit 102 are sequentially assembled into cam frame 106. Thereafter, cam frame 106 having the assembled components is assembled into one-group unit 101 and then is assembled into exterior unit 107. Lens barrel 100 is completed by assembling the components in this order.

Subsequently, lens barrel 100 assembled into rear frame unit 109 with substrate unit 108 is attached to camera body 1 via lens mount 110 and light-shielding frame 111.

Substrate unit 108 is a unit for driving lens barrel 100 and includes a printed board on which electrical components, electrical contacts and the like are mounted. Rear frame unit 109 is a member covering the outer surface of one end of exterior unit 107 near camera body 1. Lens mount 110 is a connecting component for connecting and fixing lens barrel 100 and rear frame unit 109 to camera body 1. Light-shielding frame 111 is a member that is disposed between lens mount 110 and camera body 1 and blocks undesired light.

Lens barrel 100 is configured to rotate cam frame 106 in response to the rotation of a zoom ring provided on exterior unit 107. Lens barrel 100 is configured to move one-group unit 101, two-group unit 102, three-four group unit 103, and five-group unit 104 in the direction of an optical axis when cam frame 106 rotates. Each of the units includes a cam pin to be engaged with a cam groove formed on cam frame 106. Moreover, each of the units includes straight keys to be engaged with groove portions (first groove portions 61a and 61b and second groove portions 62a and 62b) formed on fixed frame 105. With this configuration, the units are configured to move relative to fixed frame 105 and cam frame 106 in the direction of the optical axis.

### [2. Moving Mechanism]

Subsequently, fixed frame 105 and two-group unit 102 will be illustrated to specifically describe a moving mechanism for the units, fixed frame 105, and cam frame 106 made of resin.

### [2-1. Fixed Frame]

Fixed frame 105 will be first discussed below.

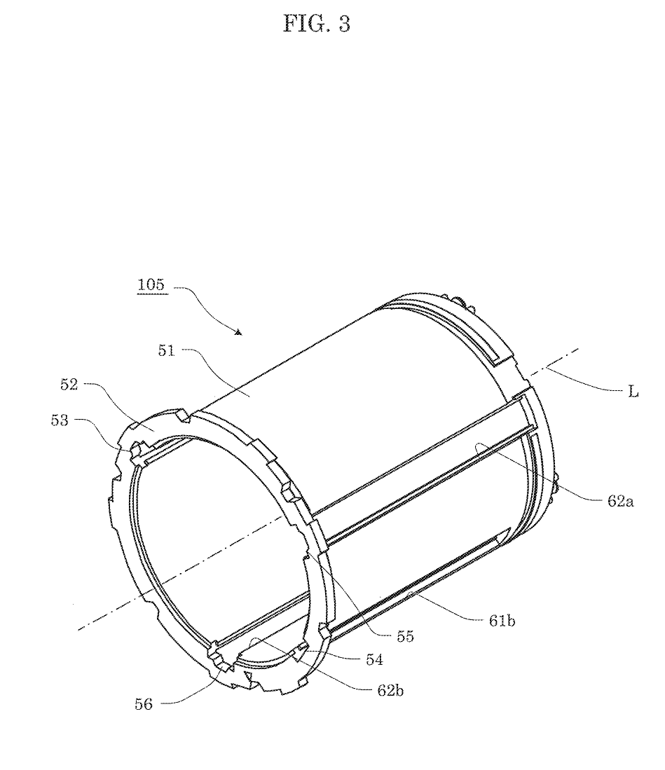

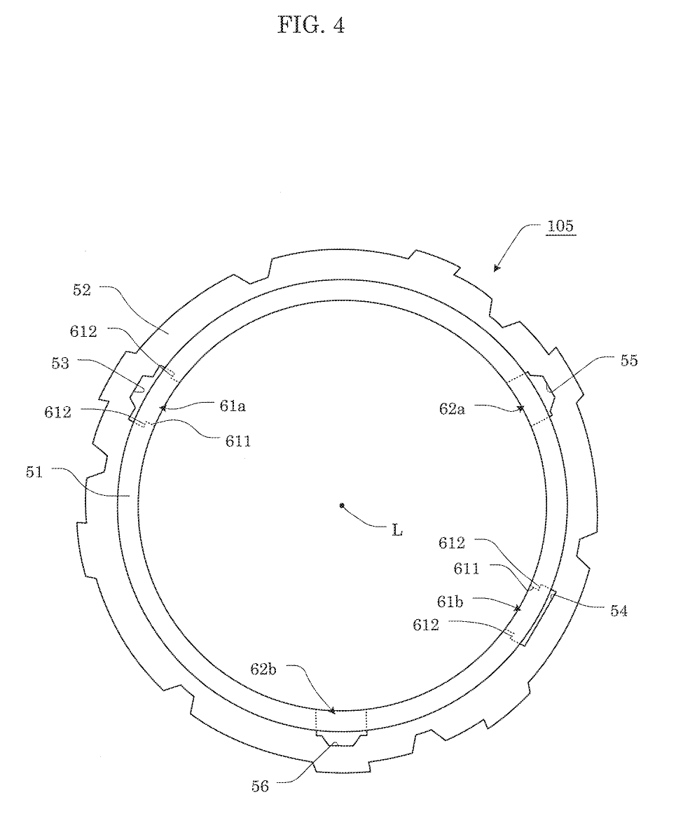

FIG. 3 is a perspective view illustrating the schematic configuration of fixed frame 105 according to the embodiment. FIG. 4 is a front view illustrating the schematic configuration of fixed frame 105 according to the embodiment. As illustrated in FIGS. 3 and 4, fixed frame 105 includes cylindrical part 51 and flange 52 integrally formed on the subject-side end of cylindrical part 51.

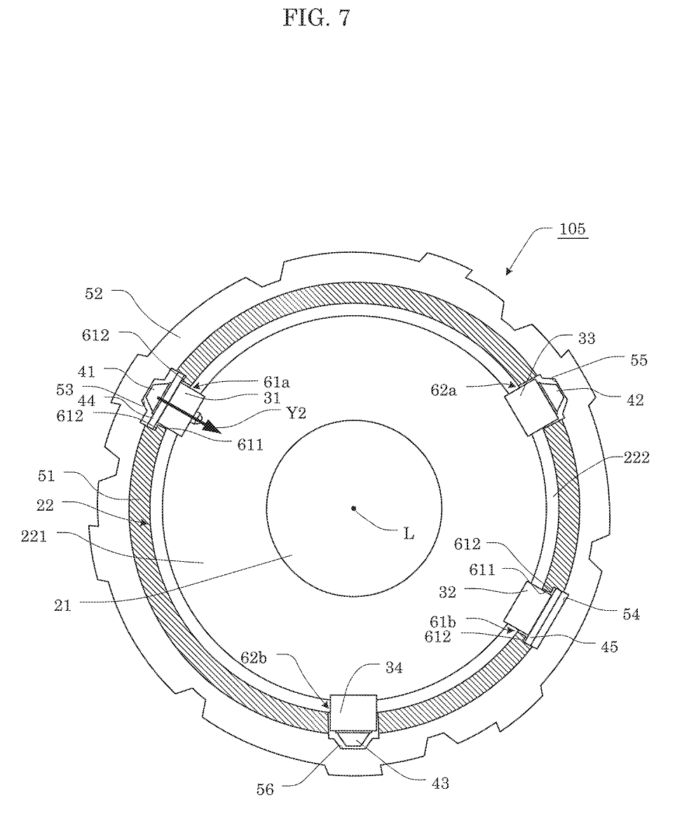

Cylindrical part 51 has paired first groove portions 61a and 61b that penetrate cylindrical part 51 and extend substantially parallel with optical axis L of lens barrel 100. Paired first groove portions 61a and 61b serves as guide portions that guide a linear movement of two-group unit 102. Paired first groove portions 61a and 61b are opposed to each other with optical axis L interposed between the groove portions. Specifically, first groove portions 61a and 61b penetrate cylindrical part 51. Each of the groove portions includes slit 611 extending substantially parallel with optical axis L and paired non-penetrating edge portions 612 extending substantially parallel with slit 611. First cam pin 41 of two-group unit 102 penetrates first groove portion 61a of the pair and radially projects outward (see FIG. 7).

Moreover, cylindrical part 51 has paired second groove portions 62a and 62b that penetrate cylindrical part 51 and extend substantially parallel with optical axis L of lens barrel 100. Paired second groove portions 62a and 62b and first groove portion 61a are arranged along the periphery of cylindrical part 51 at regular intervals. Second cam pins 42 and 43 of two-group unit 102 penetrate paired second groove portions 62a and 62b and radially project outward (see FIG. 7). Second cam pin 42 radially projects outward from second groove portion 62a of fixed frame 105 and engages with the cam groove of cam frame 106. Second cam pin 43 radially projects outward from second groove portion 62b of fixed frame 105 and engages with the cam groove of cam frame 106.

Flange 52 radially extends outward from the subject-side end of cylindrical part 51 so as to surround cylindrical part 51. Flange 52 has notches 53 to 56 at the positions of paired first groove portions 61a and 61b and paired second groove portions 62a and 62b. Specifically, at the position of first groove portion 61a in flange 52, notch 53 has a shape corresponding to first cam pin 41 and straight key 44 of two-group unit 102. Notch 53 and first groove portion 61a connect to each other. At the position of first groove portion 61b in flange 52, notch 54 is formed with a shape corresponding to straight key 45 of two-group unit 102. Notch 54 and first groove portion 61b communicate with each other. At the position of second groove portion 62a in flange 52, notch 55 is formed with a shape corresponding to second cam pin 42 of two-group unit 102. Notch 55 and second groove portion 62a communicate with each other. Moreover, at the position of second groove portion 62b in flange 52, notch 56 is formed with a shape corresponding to second cam pin 43 of two-group unit 102. Notch 56 and second groove portion 62b communicate with each other. In this case, “shape corresponding to” means a shape that allows the passage of an object. Thus, when two-group unit 102 is assembled into fixed frame 105, the projections (first cam pin 41, second cam pins 42 and 43, and straight keys 44 and 45) of two-group unit 102 pass through notches 53 to 56.

### [2-2. Two-Group Unit]

Two-group unit 102 will be described below.

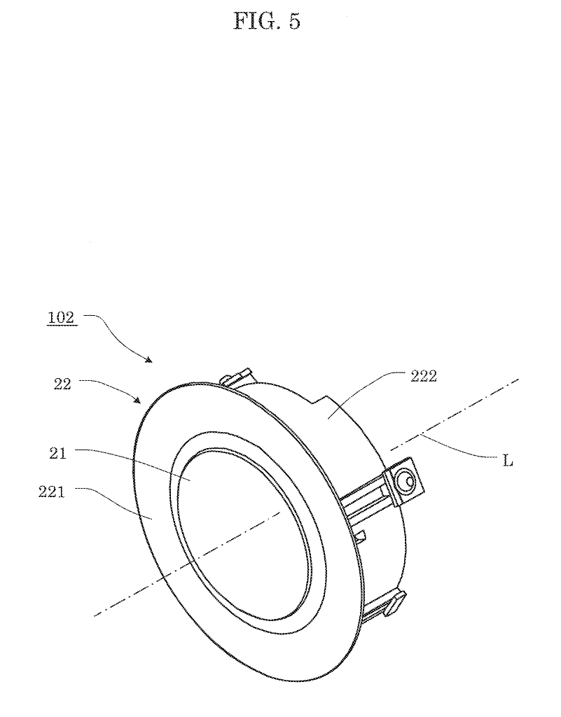

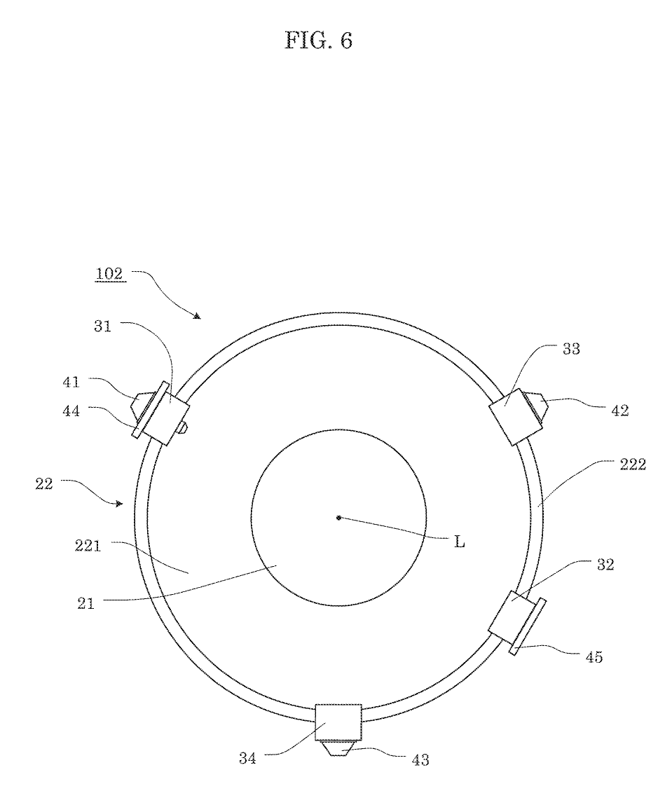

FIG. 5 is a perspective view illustrating the schematic configuration of two-group unit 102 according to the embodiment. FIG. 6 is a front view illustrating the schematic configuration of two-group unit 102 according to the embodiment. FIG. 7 is a front view illustrating two-group unit 102 assembled into fixed frame 105 according to the embodiment. In FIG. 7, cylindrical part 51 of fixed frame 105 is illustrated in cross section.

As illustrated in FIGS. 5 to 7, two-group unit 102 includes lens 21 and lens frame 22 that holds lens 21.

Lens frame 22 is a frame that moves in conjunction with the rotation of cam frame 106 so as to move straight forward with respect to fixed frame 105. Lens frame 22 includes circular holding part 221 that holds lens 21 and cylindrical wall part 222 that is continuously formed over holding part 221 so as to surround holding part 221.

Wall part 222 has four support portions (first support portion 31, second support portion 32, third support portion 33, fourth support portion 34) that are arranged along the periphery of wall part 222 at predetermined intervals so as to radially project outward. First support portion 31, second support portion 32, third support portion 33, and fourth support portion 34 are disposed for paired first groove portions 61a and 61b and paired second groove portions 62a and 62b, respectively, on wall part 222. Specifically, first support portion 31 corresponds to first groove portion 61a, second support portion 32 corresponds to first groove portion 61b, third support portion 33 corresponds to second groove portion 62a, and fourth support portion 34 corresponds to second groove portion 62b. Thus, first support portion 31, third support portion 33, and fourth support portion 34 are arranged along the periphery of wall part 222 at regular intervals. Moreover, first support portion 31 and second support portion 32 are disposed so as to be opposed to each other with optical axis L interposed therebetween. Each of the support portions supports allocated one of first cam pin 41, paired second cam pins 42 and 43, paired straight keys 44 and 45, and urging portion 46.

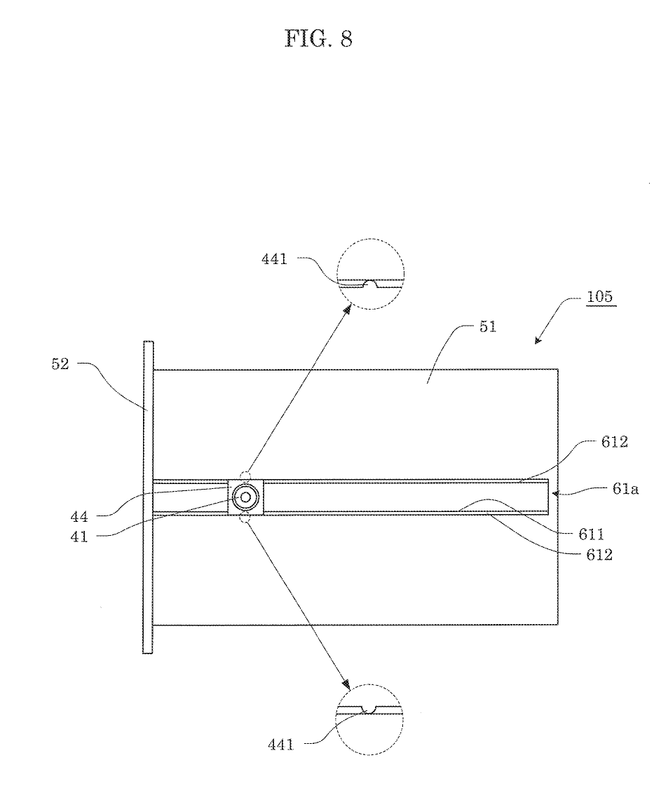

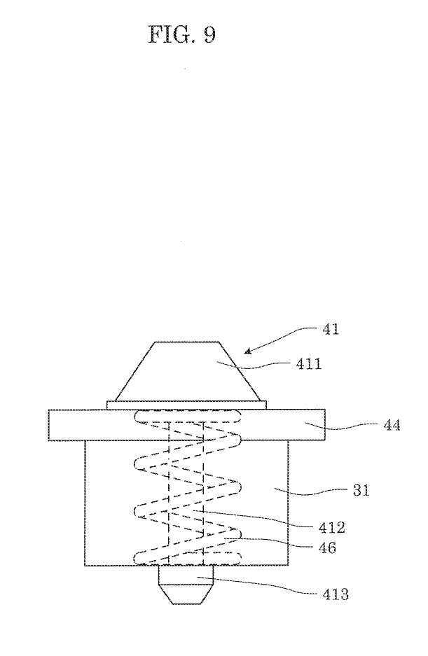

FIG. 8 is a side view illustrating first support portion 31 assembled into fixed frame 105 according to the embodiment. In FIG. 8, straight key 44 of first support portion 31 is illustrated in plan view. FIG. 9 is a schematic diagram illustrating the inner structure of first support portion 31 according to the embodiment.

As illustrated in FIGS. 6 to 9, first support portion 31 supports first cam pin 41, straight key 44, and urging portion 46. First cam pin 41 is a cam pin that penetrates first groove portion 61a so as to radially project outward from first groove portion 61a and engage with the cam groove of cam frame 106. First cam pin 41 includes head portion 411, shaft portion 412, and retaining portion 413 that are integrally formed. Head portion 411 has a shape of a substantially truncated cone and radially projects outward from first support portion 31. Shaft portion 412 is a shaft connecting head portion 411 and retaining portion 413. Retaining portion 413 has a larger diameter than shaft portion 412. Retaining portion 413 projects from first support portion 31 toward optical axis L and is caught by first support portion 31. This prevents first cam pin 41 from being removed from first support portion 31 even if an urging force is applied from urging portion 46.

Straight key 44 is a plate-like portion guided by first groove portion 61a. First cam pin 41 projects from the center of straight key 44. Straight key 44 is disposed between paired edge portions 612 of first groove portion 61a. Straight key 44 has a shape of a rectangle. Projections 441 having convex surfaces are formed on both ends of straight key 44, the ends being opposed to paired edge portions 612. Paired projections 441 is in contact with inner peripheral surfaces constituting paired edge portions 612, thereby restricting the rotation of straight key 44 about optical axis L. Moreover, projections 441 make point contact with an inner peripheral surface constituting first groove portion 61a in the plan view of straight key 44. This reduces a frictional force when straight key 44 moves straight forward along first groove portion 61a. If straight key 44 is in contact with an inner peripheral surface constituting first groove portion 61a (paired edge portions 612), first support portion 31 is separated from an inner peripheral surface constituting first groove portion 61a (slit 611). In other words, first support portion 31 is not guided by first groove portion 61a during a straight forward movement.

Urging portion 46 is an elastic member that urges first cam pin 41 in the projecting direction of first cam pin 41 as illustrated in FIG. 9. Specifically, urging portion 46 is a coil spring that is disposed between head portion 411 and retaining portion 413 while shaft portion 412 of first cam pin 41 is inserted. If a pressing force is not applied to first cam pin 41, urging portion 46 is stretched as illustrated in FIG. 9. In this state, retaining portion 413 of first cam pin 41 is caught by first support portion 31 and head portion 411 projects to a highest level from first support portion 31. This state is equivalent to a state before two-group unit 102 is assembled into cam frame 106.

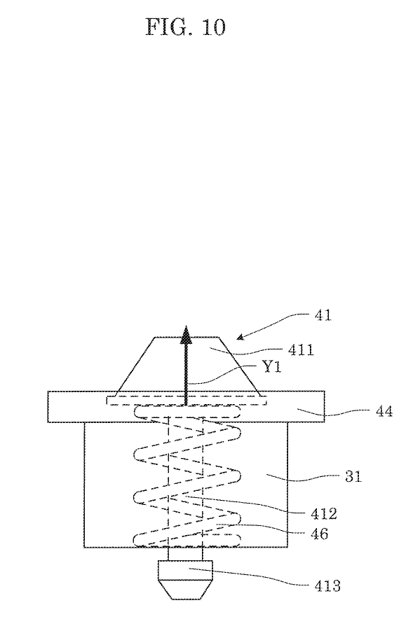

When two-group unit 102 is assembled into cam frame 106 and first cam pin 41 is engaged with the cam groove of cam frame 106, a pressing force is applied to first cam pin 41. This retracts head portion 411 of first cam pin 41 into first support portion 31, thereby compressing urging portion 46. FIG. 10 is a schematic diagram illustrating a compressed state of urging portion 46 according to the embodiment. Specifically, FIG. 10 corresponds to FIG. 9. As illustrated in FIG. 10, the restoring force of compressed urging portion 46 is applied to first cam pin 41 as an urging force applied in the projecting direction of first cam pin 41 (see arrow Y1 in FIG. 10). Thus, lens frame 22 receives an urging force applied from first cam pin 41 toward optical axis L (see arrow Y2 in FIG. 7).

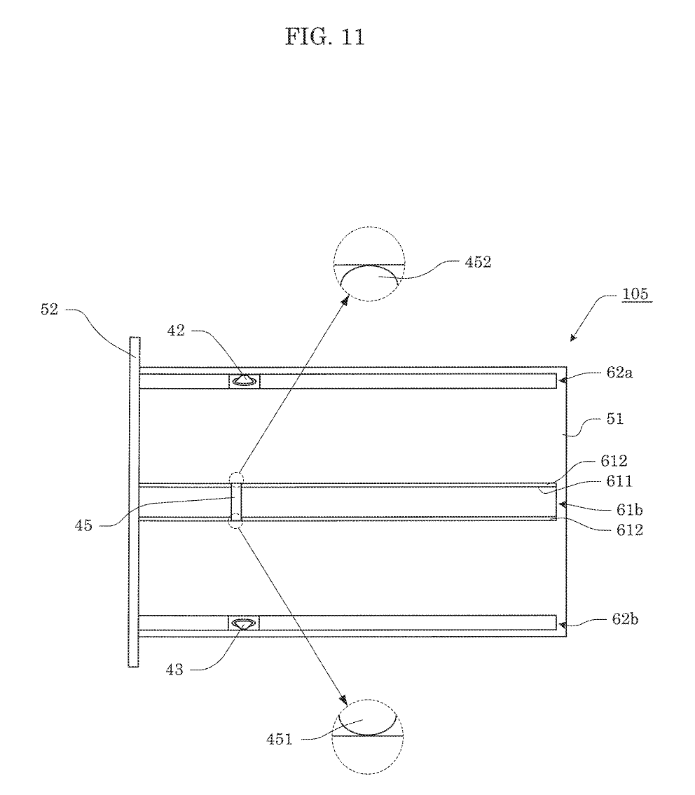

FIG. 11 is a side view illustrating second support portion 32 assembled into fixed frame 105 according to the embodiment. In FIG. 11, straight key 45 of second support portion 32 is illustrated in plan view.

As illustrated in FIGS. 6, 7, and 11, second support portion 32 supports straight key 45 at a position opposed to first support portion 31 with optical axis L interposed between the support portions. On first support portion 31, as described above, an urging force is applied from first cam pin 41 to lens frame 22 in the direction of arrow Y2 (urging direction). In other words, first groove portion 61a, first support portion 31, and straight key 44 are opposed to first groove portion 61b, second support portion 32, and straight key 45 in the urging direction with optical axis L interposed therebetween.

Straight key 45 is a plate-like portion guided by first groove portion 61b. Straight key 45 is disposed between paired edge portions 612 of first groove portion 61b. Straight key 45 has a shape of a rectangle. Curved surfaces on both ends of straight key 45 project outward from the periphery of straight key 45, the ends being opposed to paired edge portions 612. Ends 451 and 452 of straight key 45 are in contact with inner peripheral surfaces constituting paired edge portions 612, thereby restricting the rotation of straight key 45 about optical axis L. Straight key 45 is in contact with an inner peripheral surface constituting first groove portion 61b and straight key 44 is in contact with an inner peripheral surface constituting first groove portion 61a, thereby securely restricting the rotation of lens frame 22.

Moreover, ends 451 and 452 of straight key 45 make point contact with an inner peripheral surface constituting first groove portion 61b in the plan view of straight key 45. This reduces a frictional force when straight key 45 moves straight forward along first groove portion 61b.

As illustrated in FIGS. 6 and 7, third support portion 33 supports second cam pin 42. Second cam pin 42 is a cam pin that penetrates second groove portion 62a of fixed frame 105 so as to radially project outward from second groove portion 62a and engage with the cam groove of cam frame 106. Specifically, second cam pin 42 has a shape of a truncated cone. Second cam pin 42 radially projects outward from third support portion 33. Second cam pin 42 is fixed to third support portion 33 and does not change the amount of projection.

Moreover, third support portion 33 is separated from an inner peripheral surface constituting second groove portion 62a. In other words, third support portion 33 is not guided by second groove portion 62a during a straight forward movement of lens frame 22.

Fourth support portion 34 supports second cam pin 43. Second cam pin 43 is a cam pin that radially projects outward from second groove portion 62b of fixed frame 105 and engages with the cam groove of cam frame 106. Specifically, second cam pin 43 has a shape of a truncated cone. Second cam pin 43 radially projects outward from fourth support portion 34. Second cam pin 43 is fixed to fourth support portion 34 and does not change the amount of projection.

Moreover, fourth support portion 34 is separated from an inner peripheral surface constituting second groove portion 62b. In other words, fourth support portion 34 is not guided by second groove portion 62b during a straight forward movement of lens frame 22.

### [3. Effects Etc.]

As described above, according to the embodiment, lens barrel 100 includes: fixed frame 105; cam frame 106 that rotates with respect to fixed frame 105; and lens frame 22 that moves in conjunction with the rotation of cam frame 106 and moves straight forward along fixed frame 105. Here, fixed frame 105 has a pair of first groove portions 61a, 61b, a pair of first groove portions 61a, 61b penetrating fixed frame 105 and extending substantially parallel with an optical axis L. Lens frame 22 includes: first cam pin 41 that has a shape of a truncated cone, projects from one first groove portion 61a of pair of first groove portions 61a, 61b, and engages with cam frame 106; a pair of straight keys 44, 45 guided by pair of first groove portions 61a, 61b respectively; and urging portion 46 that urges first cam pin 41 in a projecting direction of first cam pin 41. First cam pin 41 is provided only on one straight key of pair of straight keys 44, 45. Pair of first groove portions 61a, 61b are opposed to each other in an urging direction of first cam pin 41 with optical axis L interposed between pair of first groove portions 61a, 61b.

With this configuration, paired first groove portions 61a and 61b are opposed to each other in the urging direction of first cam pin 41 with optical axis L interposed between the groove portions. Thus, paired straight keys 44 and 45 guided by paired first groove portions 61a and 61b, respectively, are also similarly disposed. Lens frame 22 also includes first cam pin 41 that projects from first groove portion 61a and engages with cam frame 106. Urging portion 46 urges overall lens frame 22 via first cam pin 41. At this point, paired straight keys 44 and 45 are opposed to each other in the urging direction of first cam pin 41 and thus urging from first cam pin 41 presses paired straight keys 44 and 45 in cam frame 106. Thus, lens frame 22 can be held by paired straight keys 44 and 45, so that the number of holding points can be smaller than in the related art. Thus, lens frame 22 is securely urged in a direction orthogonal to optical axis L, that is, a direction along which paired straight keys 44 and 45 are opposed to each other; meanwhile, a movement of lens frame 22 in rotation direction about optical axis L can be restricted by paired straight keys 44 and 45.

Furthermore, fixed frame 105 has a pair of second groove portions 62a, 62b, a pair of second groove portions 62a, 62b penetrating fixed frame 105 and extending substantially parallel with optical axis L. Lens frame 22 includes a pair of second cam pins 42, 43 that each have a shape of a truncated cone, project from pair of second groove portions 62a, 62b respectively, and engage with cam frame 106.

With this configuration, paired second cam pins 42 and 43 engaged with the cam groove of cam frame 106 are provided on lens frame 22 and lens frame 22 is urged in the direction orthogonal to optical axis L, that is, the direction along which paired straight keys 44 and 45 are opposed to each other. This securely presses paired second cam pins 42 and 43 to cam frame 106. Since first cam pin 41 and paired second cam pins 42 and 43 each have a shape of a truncated cone, lens frame 22 can be securely positioned with respect to a position in the direction of optical axis L and a position on a plane orthogonal to the optical axis. If cam frame 106 is made of resin, first cam pin 41 and paired second cam pins 42 and 43 each typically have a shape of a truncated cone. In the case of truncated cones, a position in the direction orthogonal to optical axis L is determined as well as a height in the direction of optical axis L. Positioning in the direction of optical axis L and on the plane orthogonal to optical axis L may cause excessive restraint on fixed frame 105. In order to avoid such excessive restraint, backlash may be eliminated but the accuracy of position may decrease. In contrast, as described above, fixed frame 105 does not position lens frame 22 but restricts the rotation of lens frame 22 and urges lens frame 22 with first cam pin 41. This can improve the accuracy of positioning while avoiding excessive restraint.

Furthermore, one first groove portion 61a, 61b and each of pair of second groove portions 62a, 62b are arranged along a periphery fixed frame 105 at regular intervals.

With the above structure, in which one first groove portion 61a, 61b and each of pair of second groove portions 62a, 62b are arranged along a periphery fixed frame 105 at regular intervals, first cam pin 41 and paired second cam pins 42 and 43 are also arranged along the periphery of fixed frame 105 at regular intervals. This can achieve balanced engagement with cam frame 106 as long as first cam pin 41 and paired second cam pins 42 and 43 are arranged along the periphery of fixed frame 105 at regular intervals. Thus, the rotation of cam frame 106 can be more stably converted into a straight forward movement of lens frame 22.

Furthermore, each of pair of straight keys 44, 45 makes point contact with an inner peripheral surface constituting a corresponding one of pair of first groove portions 61a and 61b in a plan view of straight key 44, 45.

The above structure, in which each of pair of straight keys 44, 45 makes point contact with an inner peripheral surface constituting a corresponding one of pair of first groove portions 61a and 61b in a plan view of straight key 44, 45, can reduce a frictional force when straight keys 44 and 45 move straight forward along first groove portions 61a and 61b. Thus, lens frame 22 can more smoothly move straight forward. In this case, “point contact in the plan view” substantially includes point contact and line contact.

### Other Embodiments

As described above, the embodiment has been provided as one example of the technique disclosed in the present application. However, the technique according to the present disclosure is not limited to the embodiment and may include other embodiments with appropriate modifications, substitutions, additions, or eliminations for the above embodiment.

The embodiment described the moving mechanism for fixed frame 105 and two-group unit 102. The features of the present disclosure are also applicable to, for example, a moving mechanism for fixed frame 105 and other units (including three-four group unit 103 and five-group unit 104). Moreover, the embodiment illustrated first cam pin 41 and paired second cam pins 42 and 43 that are provided on lens frame 22. The lens frame may only include the first cam pin. In this case, second groove portions 62a and 62b are also unnecessary.

In the above embodiment, it has been described that one first groove portion 61a and each of pair of second groove portions 62a, 62b are arranged along periphery fixed frame 105 at regular intervals. However, it is not necessary to arrange these groove portions at regular intervals.

In the above embodiment, it has been described that each of pair of straight keys 44, 45 makes point contact with an inner peripheral surface constituting a corresponding one of pair of first groove portions 61a and 61b in a plan view of straight key 44, 45. However, it is also possible that straight key 44, 45 makes surface contact with the inner peripheral surface constituting a corresponding one of pair of first groove portions 61a and 61b.

The embodiment illustrated third support portion 33 and fourth support portion 34 that only support second cam pins 42 and 43. Like first support portion 31 and second support portion 32, third support portion 33 and fourth support portion 34 may support the straight keys guided by second groove portions 62a and 62b.

(Others)

Thus, the embodiments have been described as other examples of the technique according to the present disclosure. The accompanying drawings and the detailed description are therefore given.

Therefore, in order to provide the examples of the technique, among the constituent elements illustrated in the accompanying drawings and described in the detailed description, there may be constituent elements not essential to solve the problem as well as essential constituent elements. It is therefore not reasonable to easily consider these unessential constituent elements as essential merely because the elements are illustrated in the accompanying drawings or described in the detailed description.

It should also be noted that, since the foregoing embodiments exemplify the technique according to the present disclosure, various modifications, substitutions, additions, or eliminations, for example, may be made in the embodiments within a scope of the appended claims or within a scope of equivalency of the claims. Furthermore, the embodiments may be combined.

### INDUSTRIAL APPLICABILITY

The present disclosure is applicable to a zoom lens barrel.

What is claimed is:

1. A lens barrel comprising:
a fixed frame;
a cam frame that rotates with respect to the fixed frame; and
a lens frame that moves in conjunction with the rotation of the cam frame and moves straight forward along the fixed frame,
wherein the fixed frame has a pair of first groove portions, the pair of first groove portions penetrating the fixed frame and extending substantially parallel with an optical axis,
the lens frame includes:
a first cam pin that has a shape of a truncated cone, projects from one first groove portion of the pair of first groove portions, and engages with the cam frame;
a pair of straight keys guided by the pair of first groove portions respectively; and
an urging portion that urges the first cam pin in a projecting direction of the first cam pin,
the first cam pin is provided only on one straight key of the pair of straight keys, and
the pair of first groove portions are opposed to each other in an urging direction of the first cam pin with the optical axis interposed between the pair of first groove portions.

2. The lens barrel according to claim 1,
wherein the fixed frame has a pair of second groove portions, the pair of the second groove portions penetrating the fixed frame and extending substantially parallel with the optical axis, and
the lens frame includes a pair of second cam pins that each have a shape of a truncated cone, project from the pair of second groove portions respectively, and engage with the cam frame.

3. The lens barrel according to claim 2,
wherein the one first groove portion and each of the pair of second groove portions are arranged along a periphery the fixed frame at regular intervals.

4. The lens barrel according to claim 2,
wherein the lens frame includes a pair of support portions that support the pair of second cam pins respectively,
the pair of the support portion support the pair of second cam pins such that the pair of second cam pins project from the pair of second groove portions, and
each of the pair of support portions is separated from an inner peripheral surface constituting a corresponding one of the pair of the second groove portions.

5. The lens barrel according to claim 1,
wherein each of the pair of straight keys makes point contact with an inner peripheral surface constituting a corresponding one of the pair of the first groove portions in a plan view of the straight key.
